(19) United States
(12) Patent Application Publication
(10) Pub. No.: US 2013/0178956 A1
(43) Pub. Date: Jul. 11, 2013

(54) IDENTIFYING TOP STRENGTHS FOR A PERSON

(71) Applicants: Pramesh Vashist, Pleasanton, CA (US); Namita Panigrahi, San Ramon, CA (US); Ravi Banda, Fremont, CA (US)

(72) Inventors: Pramesh Vashist, Pleasanton, CA (US); Namita Panigrahi, San Ramon, CA (US); Ravi Banda, Fremont, CA (US)

(73) Assignee: Oracle International Corporation, Redwood Shores, CA (US)

(21) Appl. No.: 13/347,607

(22) Filed: Jan. 10, 2012

(51) Int. Cl. G06F 19/00

(52) U.S. Cl. 700/91

(57) ABSTRACT

In a method, system, apparatus, and computer-readable mediums having instructions for identifying top strengths of a person, a definition may be received for a strength and the definition comprises a first competency, a second competency, a first weight, and a second weight, profile information may be retrieved for a user from a profile management application, a value may be computed for the strength using the definition and the profile information for the user, and the value for the strength may be compared with a plurality of values for the strength from a plurality of other users.

### BACKGROUND

A common problem for employers is the identification of an employee's key competency areas. Talent management approaches tend to rely on performance reviews by managers as a way of capturing perceived competencies for an employee, such as how well the employee builds relationships and works in a team. Although performance reviews allow one to gain insight about an employee from the perspective of a manger, the performance review process alone may not allow for accurate identification of the top strengths for an employee because a strength consists of multiple behavioral and talent aspects.

Alternative approaches today may rely on a questionnaire or a survey to determine how a person perceives the world and make decisions and/or personality tests, such as Myers-Briggs type questionnaires. Such questionnaires and surveys are largely psychological measurements, including measures of knowledge, abilities, attitudes, personality traits, and education. However, identification of a set of abilities using a questionnaire does not assist that person in navigating or managing their own career.

There is no system that uses this information to find help the employee find the right type of job or identify the best successor for a key position. It is up to an individual to make the connection between what they do well and the right role for them to play in an organization. Accordingly, it is desirable to provide a technique for improved identification and communication of top strengths for an individual.

### SUMMARY

In a method, system, apparatus, and computer-readable mediums having instructions for identifying top strengths of a person, a definition may be received for a strength and the definition comprises a first competency, a second competency, a first weight, and a second weight, profile information may be retrieved for a user from a profile management application, a value may be computed for the strength using the definition and the profile information for the user, and the value for the strength may be compared with a plurality of values for the strength from a plurality of other users.

A further understanding of the nature and the advantages of particular embodiments disclosed herein may be realized by reference of the remaining portions of the specification and the attached drawings.

### BRIEF DESCRIPTION OF THE DRAWINGS

FIG. 1 illustrates a flow chart with an example of an implementation for identifying top strengths for a person.

FIG. 2 illustrates a flow chart with an example of an implementation for identifying top strengths for a person.

FIG. 3 illustrates an example of an implementation of a user interface for identifying top strengths for a person.

FIG. 4 illustrates an example of an implementation of a user interface for identifying top strengths for a person.

FIG. 5 illustrates an example of an implementation of a user interface for identifying top strengths for a person.

FIG. 6 illustrates an example of an implementation of a user interface for identifying top strengths for a person.

FIG. 7 illustrates an example of an implementation of a user interface for identifying top strengths for a person.

FIG. 8 illustrates an example of an implementation of a user interface for identifying top strengths for a person.

FIG. 9 illustrates an example of an implementation of a user interface for identifying top strengths for a person.

FIG. 10 illustrates an example of an implementation of a user interface for identifying top strengths for a person.

### DETAILED DESCRIPTION OF EMBODIMENTS

Systems, methods, apparatuses, computer readable mediums, and computer program products are described for identifying top strengths for a person. A strength may be defined by one or more competencies, where the one or more competencies represent the multiple behavioral and talent aspects of the strength. It may be desirable to view a strength as differing from a competency in that a strength of a person may consist of multiple behavioral and talent aspects. A user, such as an administrator, manager, or any other user, may provide and input a definition for the strength. The definition may provide a mathematical function for computing a value for the strength.

The function may be a formula or algorithm for determining the strength using the one or more competencies. In one or more embodiments, the function may be a weight function where elements of the function are given more “influence” or “weight” than other elements. Elements that may be weighted include, but are not limited, to one or more competencies, one or more sources for information on competencies, and/or any other elements or inputs for the function. The function may be used to compute values for strengths for a user, such as an employee or any other user.

Embodiments may rely on one or more sources to capture meaningful information or data about a person over a period of time in order to identify strengths. Sources that may be relied on include, but are not limited to, the following: profile management applications, self-assessments, peer reviews, educational course assessments, experiences, competencies, attributes, qualifications, and/or any other data captured about a person or user over time. It may be desirable to use data from existing systems that capture data over a period of time as opposed to relying on questionnaires that may be given to analyze a person's strength on the day the person answers questions on the questionnaire. The data may be stored in a database such that the data can be retrieved for computation of the function. A database may be a relational database, a file system, and/or any other collection of data.

In an embodiment, one or more strengths may be computed for a user and the strengths can be ranked in accordance with the values computed. In this way, the top ranked strengths for an individual or user may be identified. A manager and/or any other user may then evaluate a set of employees with knowledge of each employee's top strengths. A manager may then be able to compare potential candidates from a pool of employees to fill a team.

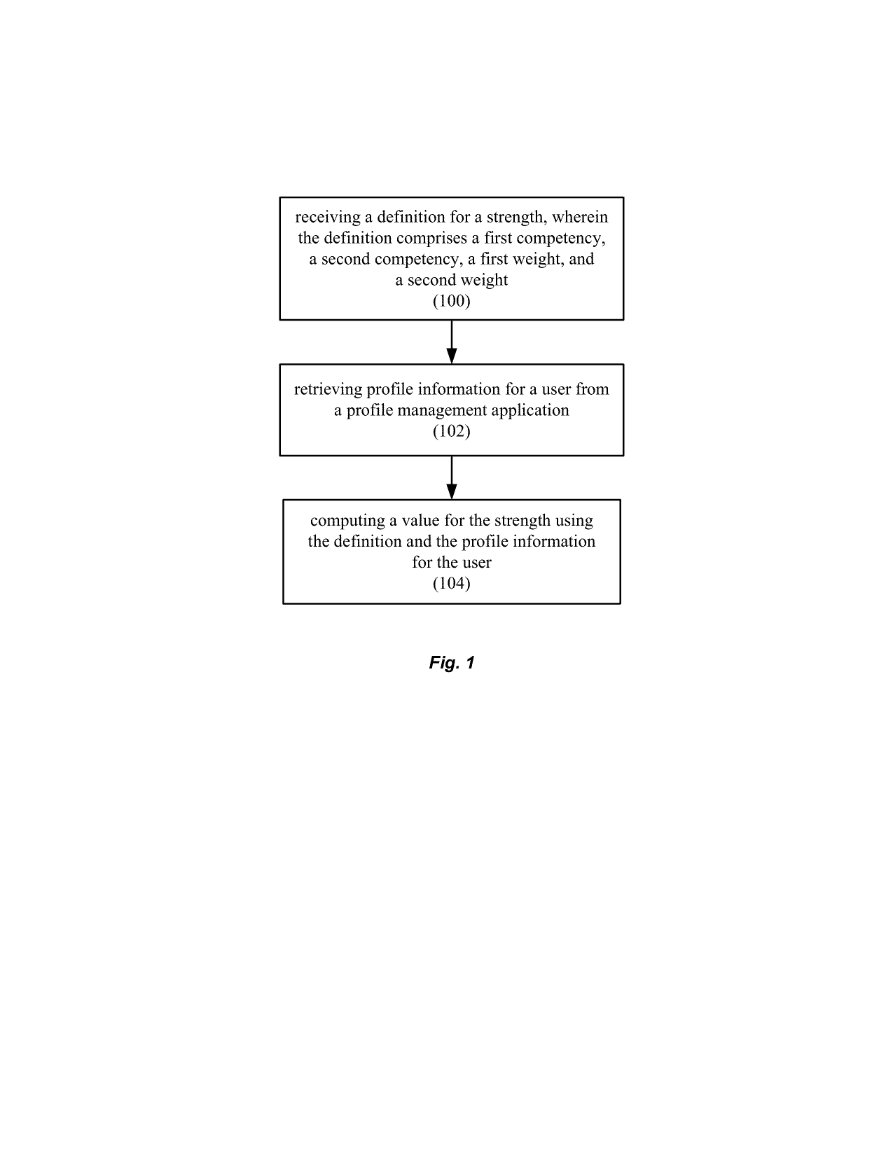

FIG. 1 illustrates a flow chart with an example of an implementation for identifying top strengths for a person. A definition for a strength may be received (100). A user, such as an administrator, may input the definition for the strength using a graphical user interface. The definition for the strength may have a first competency, a second competency, a first weight, and a second weight. For example, a strength of “harmony” may be defined, as follows: competency “teamwork” with a first weight indicating a required score of “4 out of 5 or greater,” and competency “building relationships” with a second weight indicating a required score of “3 out of 5 or greater.” A user would need a score of at least a “4 out of 5” for the competency of “teamwork” whereas a user would only need a “3 out of 5” for the competency of “building relationships.” In this example, the “teamwork” competency is of greater importance than the “building relationships” competency for the strength of “harmony.”

A competency may be any user defined content type. The competency may be an ability that a person has to do something. In particular, the competency may be an ability of a person that can be measured against a standard. For example, a competency may be a previous responsibility, a language skill, a degree, a work requirement, a particular license, an affiliation, a grade point average, a scholarship, and/or any other user defined content type.

Profile information may be retrieved for a user from a profile management application (102). Data on competencies that have been stored for the user over time may be used as a source for profile information for the user to determine the strength value for the user. In one or more embodiments, a profile management software application may have profile information on users that includes an evaluation of a user for a set of competencies. The profile information used for determining a strength may include, but is not limited to, the following: a user's own input, performance ratings of competencies input by managers, peers, instructors, or any other users. The profile information may already be stored or one or more other user's may be solicited to provide feedback on a user to determine the user's proficiency for a set of competencies. The profile information may be stored over time so that behavioral strengths can be captured as strengths change over time. For example, new competencies can identified or increased skill level in competencies, and as a result, new or increased scores for strengths may be identified for a user in nearly real time.

In an embodiment, a list of sources for profile information may be specified with the definition of the strength. A user may prioritize (e.g. weight) particular sources of profile information over other sources for a particular strength. For example, the source with assessments (e.g. performance reviews) by managers, such as an employee, may be prioritized as of greater importance to the evaluation of an employee over sources with the employee's own input (e.g. profile data input by the user).

A value for the strength may be computed using the definition and the profile information for the user (104). The strength definition may be a formula or weighted function that may be used to compute a value for the particular strength for the user. The specified sources for the strength definition may serve as input for computing the strength with the definition. The value may be used as a score for the user on the particular strength (e.g. grouping of competencies). The values may be used as a way to delimit the strengths of a user.

In an embodiment, the strengths for a user may be ranked using the values and the top strengths for the user may be determined. For example, the top strengths could be: achiever, harmony, and responsibility for a user. A manager can look at top strengths of that person (e.g. achiever, communication skills, etc.) and determine tasks and/or positions appropriate for an employee.

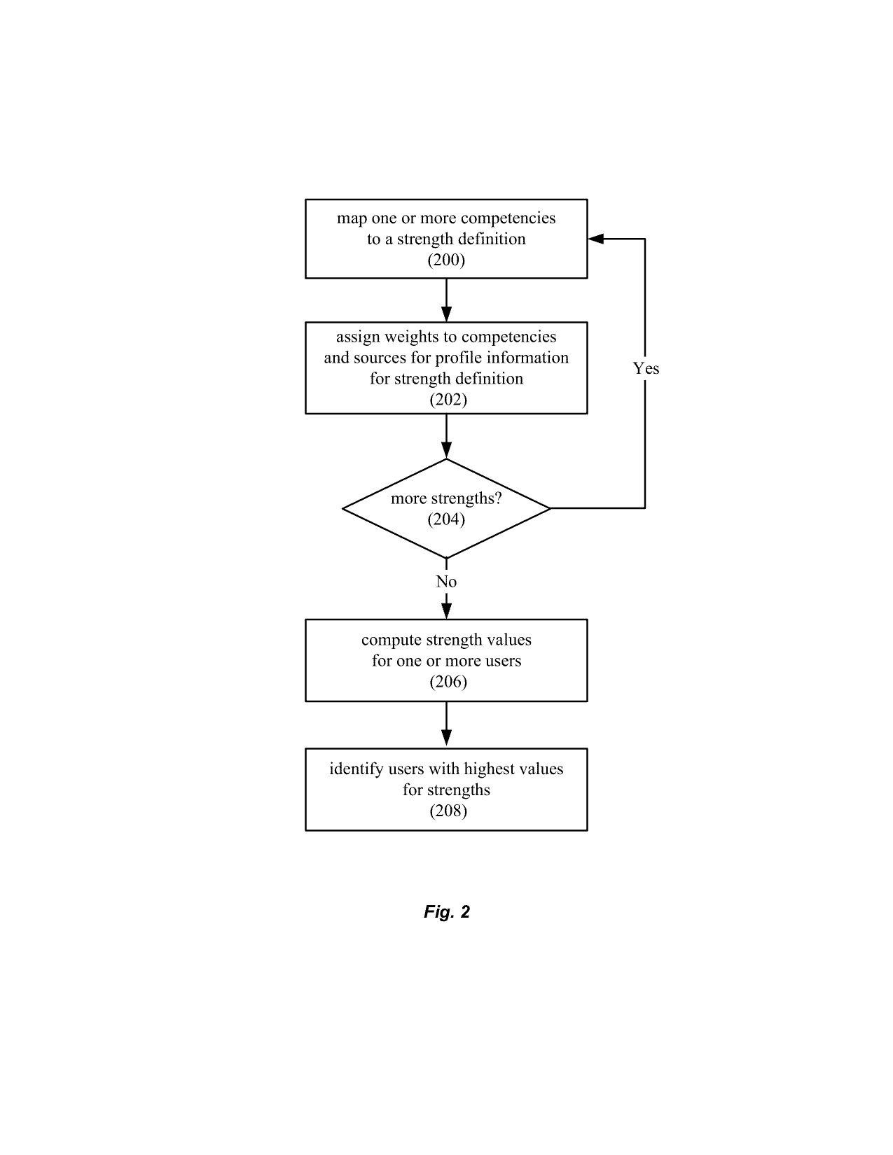

FIG. 2 illustrates a flow chart with an example of an implementation for identifying top strengths for a person. One or more competencies may be mapped to a strength definition (200). For example, the strength definition for “achiever” may be mapped to “goal-oriented,” “on-time delivery,” and “high quality work” competencies. Competencies may be user defined to meet the needs of the users. It may be desirable to define your own competencies and strengths to ensure that an employee has the right strengths for a particular position as opposed to relying on strengths provided by a third-party. In some embodiments, definitions for strengths may be provided by a third-party.

Weights for competencies may be assigned for the strength definition (204). The weighting of particular competencies may allow for prioritizing the competencies for a particular strength. For example, for an “achiever” strength, “high quality work” may be weighted (e.g. 0.9*high quality work score) to be prioritized over “on-time delivery” (e.g. 0.05*on-time delivery score and 0.05*goal oriented score). Continuing with the example, a value for “achiever” may be computed with the following definition (e.g. weighted function) : (weight1)*(high quality work competency score for user)+(weight2)*(on-time delivery competency score for user)+(weight3)*(goal oriented score for user).

Weights may also be assigned to sources for profile information with the strength definition (202). A weighted function may also be used to ensure that data from particular sources is valued over other sources of information. Although illustrated as assigning weights on a per strength definition basis, those with skill in the art that weights can be assigned for all strength definitions, none of the definitions, and/or a subset of strength definitions.

A determination may be made as to whether more strength definitions are desired (204). If more strength definitions are desired (204), then the process is repeated (200). Alternatively, if more strength definitions are not desired (204), then strength values for one or more users are computed (206).

The strength definitions may be used to compute strength values for a set of employees. Users with the highest values for strengths may be identified (208). If a particular set of strengths of is desired for a task or position, then a pool of candidates may be identified from a set of employees with the highest values for the desired strengths.

Although embodiments are described for use at the workplace, those with skill in the art will recognize that there are many applications for identifying strengths from a set of users with data tracked over time, such as at educational institutions, job applicants with professional profiles that are public accessible, public profiles on social networks, and/or any other set of users.

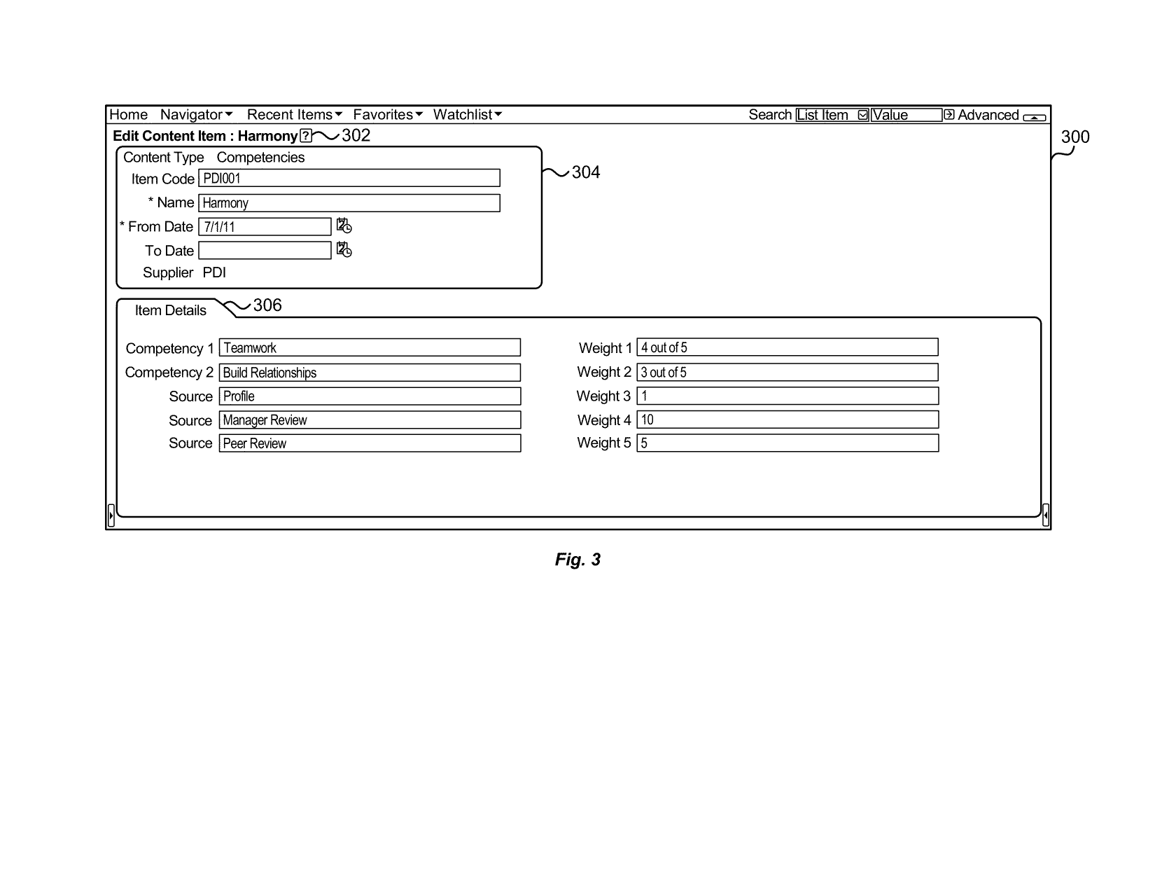

FIG. 3 illustrates an example of an implementation of a user interface for identifying top strengths for a person. A graphical user interface for defining a strength is illustrated at 300. In this example, a strength definition for “Harmony” 302 is being input by a user. Information specific to the strength definition, illustrated at 304, may be provided by the user to, such as an “Item Code” (e.g. an identification number for the strength), a “Name” for the strength (e.g. “Harmony” as illustrated), “From” and “To” dates for validity of the strength definition, and a “Supplier” name.

The strength definition itself may be input with a user interface, such as shown at 306 with “Item Detail.” The competencies may be mapped to the strength as shown at 306 with “Competency1” of “teamwork,” and “Competency2” of “build relationships.” Weights may be assigned to the competencies with “Weight1” and “Weight2” for the respective competencies. As illustrated at 306, “teamwork” competency may require a “4 out of 5” score for users to be identified as in possession of the “harmony” strength. As indicated by the “Weight 2” input of “3 out of 5” score illustrated at 306, “build relationships” competency is of lesser importance for “harmony” strength as “teamwork.”

Particular sources may be input for use with a particular strength definition. As illustrated at 306, the sources “Profile” and “Manager Review” are desired by the user for identification of the harmony strength. Weights (e.g. “Weight3”, “Weight4,” and “Weight5” at 306) may be assigned to prioritize the data retrieved from databases with profile information for users. For example, a user may prioritize “Manager Review” data over “Profile” data input by a user being evaluated.

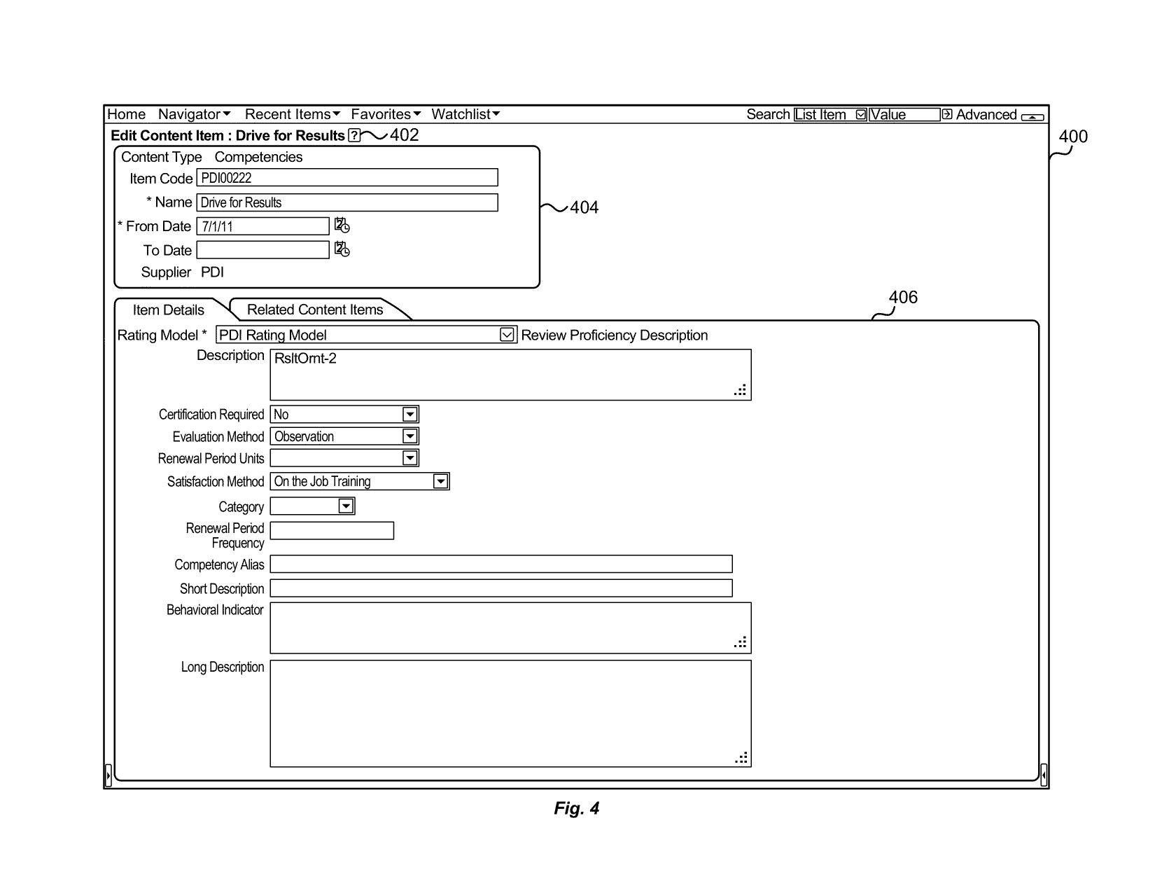

FIG. 4 illustrates an example of an implementation of a user interface for identifying top strengths for a person. FIG. 4 illustrates an example of a graphical user interface for inputting a competency definition. In this example, a competency definition for “Drive for Results” 402 is being input by a user. Information specific to the competency definition, illustrated at 404, may be provided by the user to, such as an “Item Code” (e.g. an identification number for the competency), a “Name” for the competency (e.g. “Drive for Results” as illustrated), “From” and “To” dates for validity of the competency definition, and a “Supplier” name.

The competency definition itself may be input with a user interface, such as shown at 406 with “Item Detail.” A competency may be defined with data including, but not limited to, the following illustrated at 406: a “Rating Model,” “Description,” “Certification Required” indicator, “Evaluation Method” (e.g. observation, testing, etc.), “Renewal Period Units,” “Satisfaction Method” (e.g. on-job training, coursework, instruction, etc.), “Category” for competency, “Renewal Period Frequency,” “Competency Alias,” “Short Description” (e.g. a nickname for competency), “Behavioral Indicator” (e.g. persistence), and “Long Description” (e.g. description with greater detail).

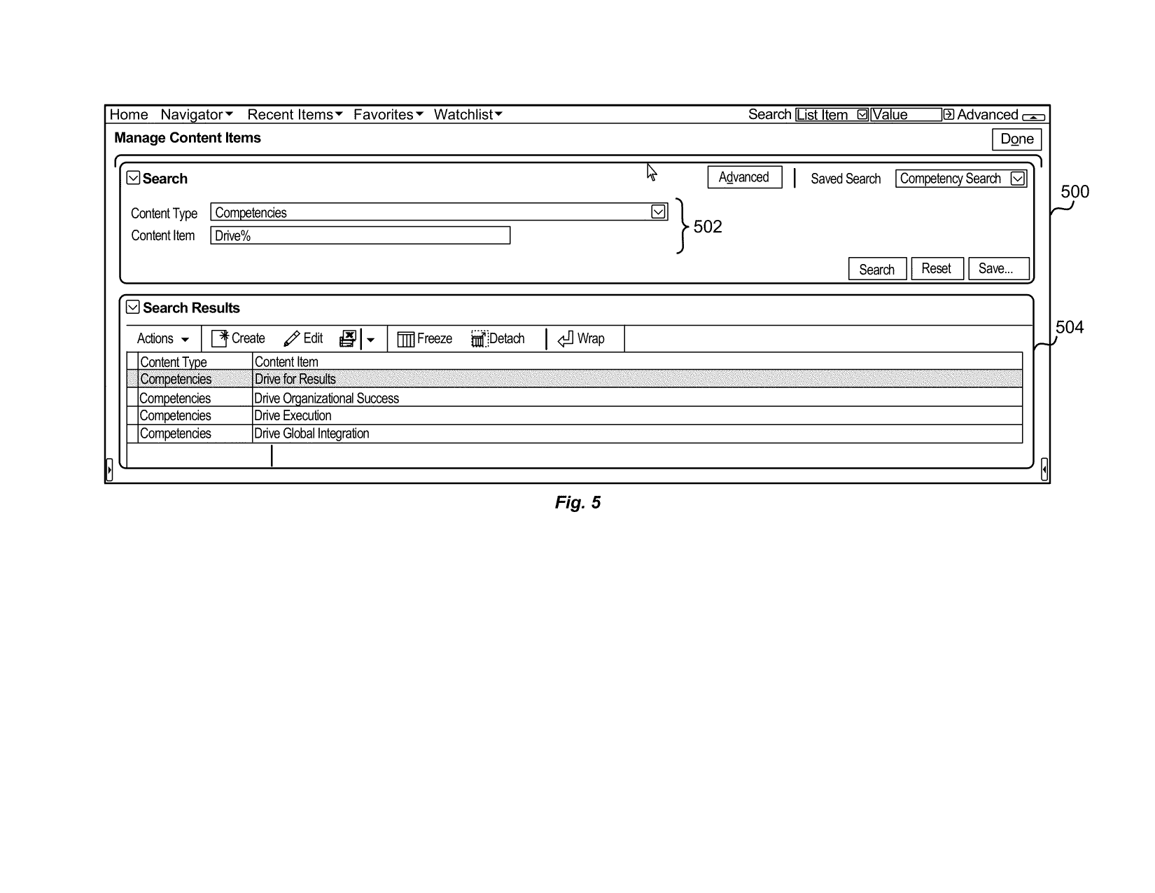

FIG. 5 illustrates an example of an implementation of a user interface for identifying top strengths for a person. An example of a user interface is provided at 500 for searching for competencies. As illustrated at 502, content of “Competencies” can be searched and competencies including “Drive” may be retrieved. As shown at 504, search results may be displayed within the user interface.

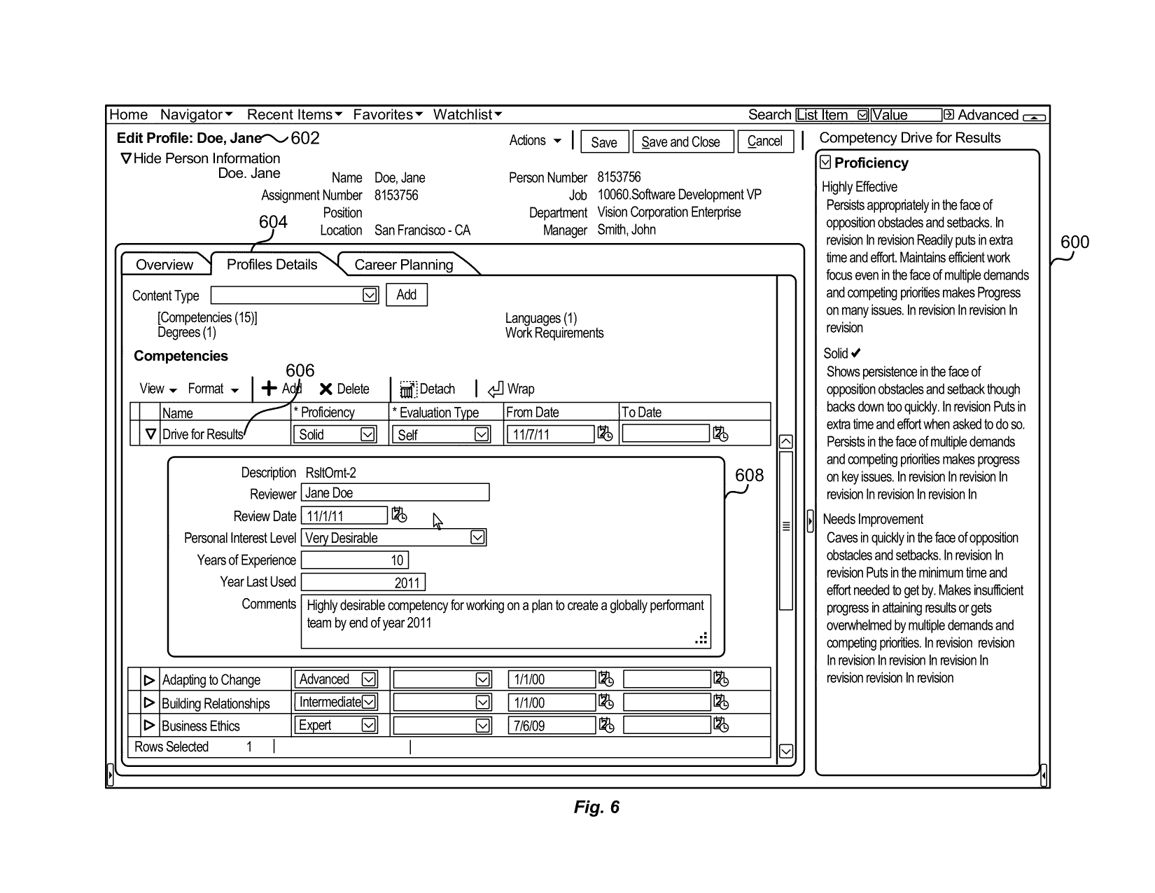

FIG. 6 illustrates an example of an implementation of a user interface for identifying top strengths for a person. FIG. 6 illustrates a profile for a user “Jane Doe” as indicated at 602. “Profile Details” at 604 allow for the user to evaluate themselves for particular competencies. As illustrated at 606, the user may evaluate themselves for “Drive for Results” competency including, but not limited to, the following: “Proficiency,” “Evaluation Type,” “From Date,” and “To Date.” Specific detail for the particular competency as illustrated at 608, may include, but is not limited to, the following: “Description,” “Reviewer,” “Review Date,” “Personal Interest Level,” “Years of Experience,” “Year Last Used,” and “Comments.”

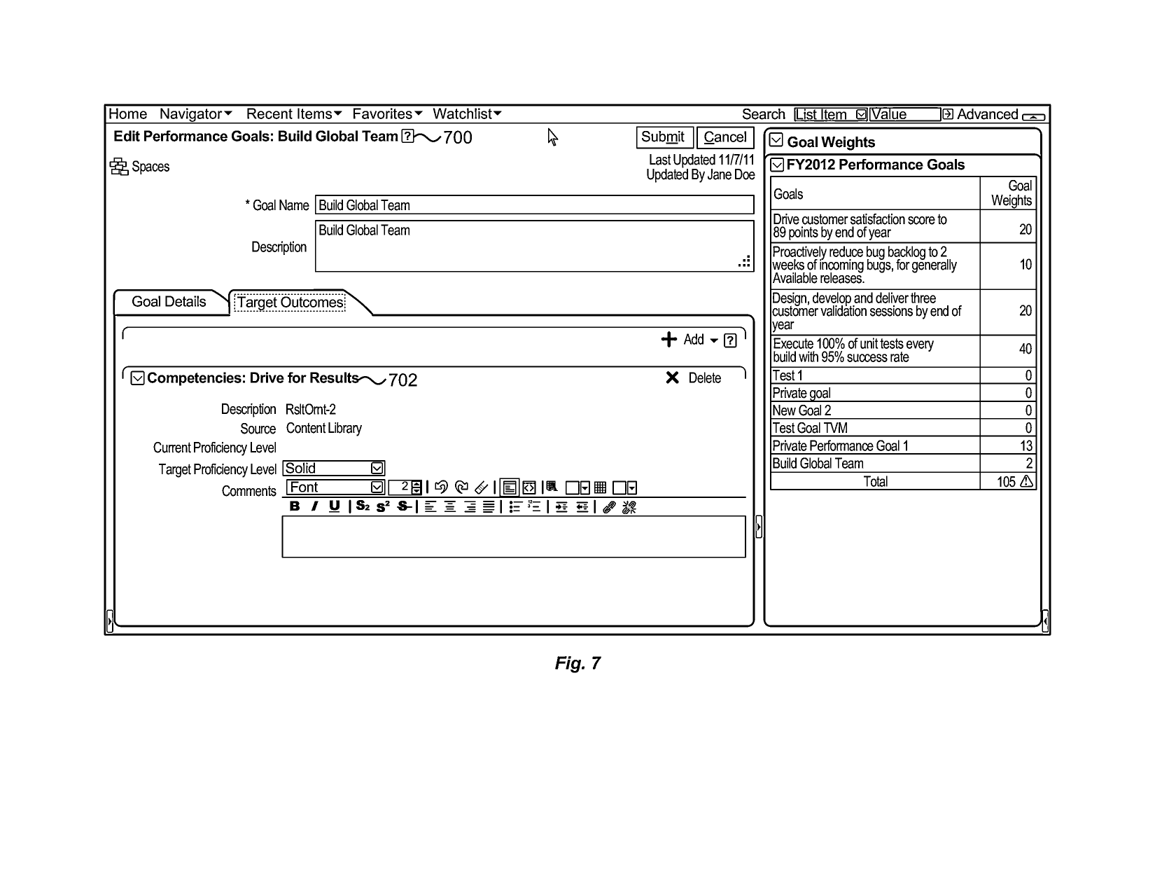

FIG. 7 illustrates an example of an implementation of a user interface for identifying top strengths for a person. FIG. 7 illustrates an example of a user interface for inputting a course review. As indicated at 700 in FIG. 7, a performance goal evaluation is provided for the course “Build Global Team.” Competencies may be associated with the course as shown at 702 with “Drive for Results.” An instructor for the course may input the “Target Proficiency” and “Comments” to evaluate the user's mastery of the competency in the particular course.

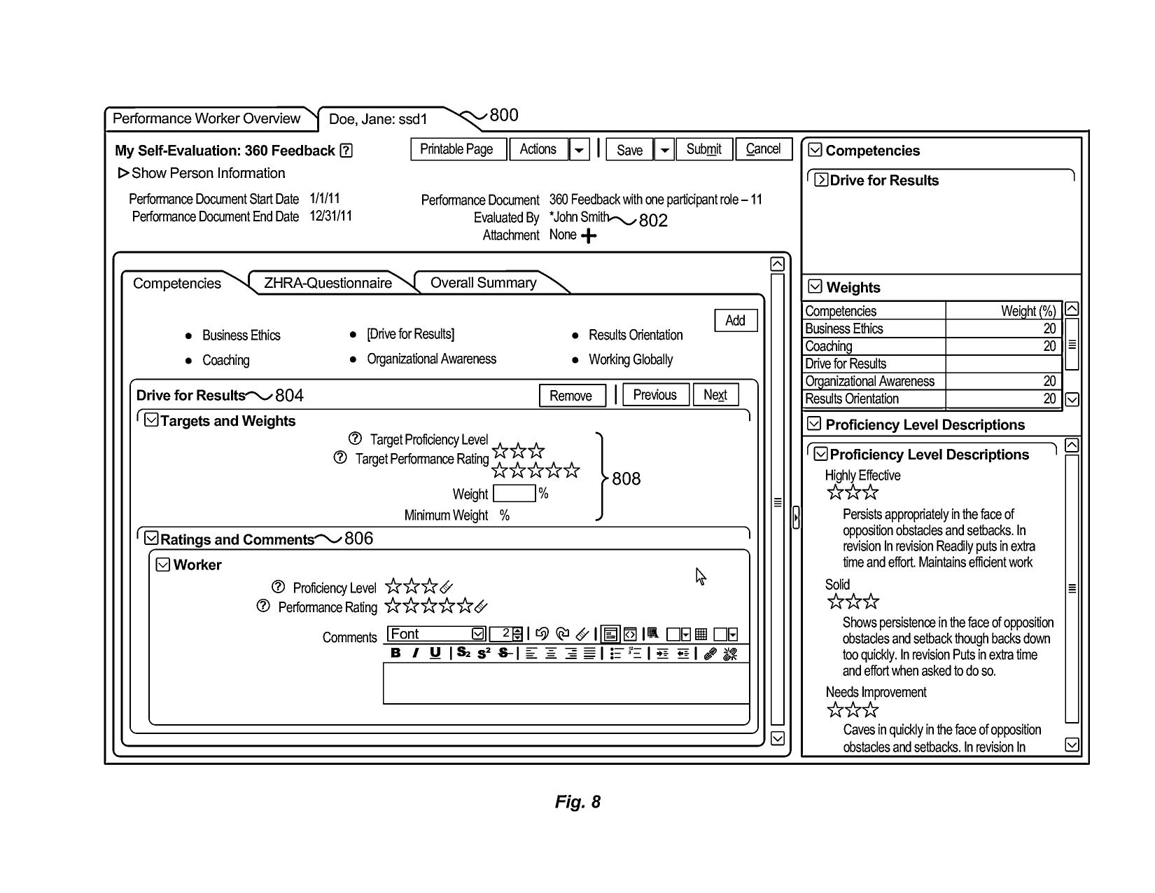

FIG. 8 illustrates an example of an implementation of a user interface for identifying top strengths for a person. FIG. 8 illustrates an example of a user interface for input of a peer review. As shown at 800, a peer review or “360 Feedback” is displayed for “Doe, Jane: ssd1.” The evaluator of “Doe, Jane” as illustrated at 802 is “John Smith.” At 804 in FIG. 8, the competency “Drive for Results” at 804 is provided for the evaluator to input proficiency levels, illustrated at 806, for the competency. At 808, target proficiency levels are displayed.

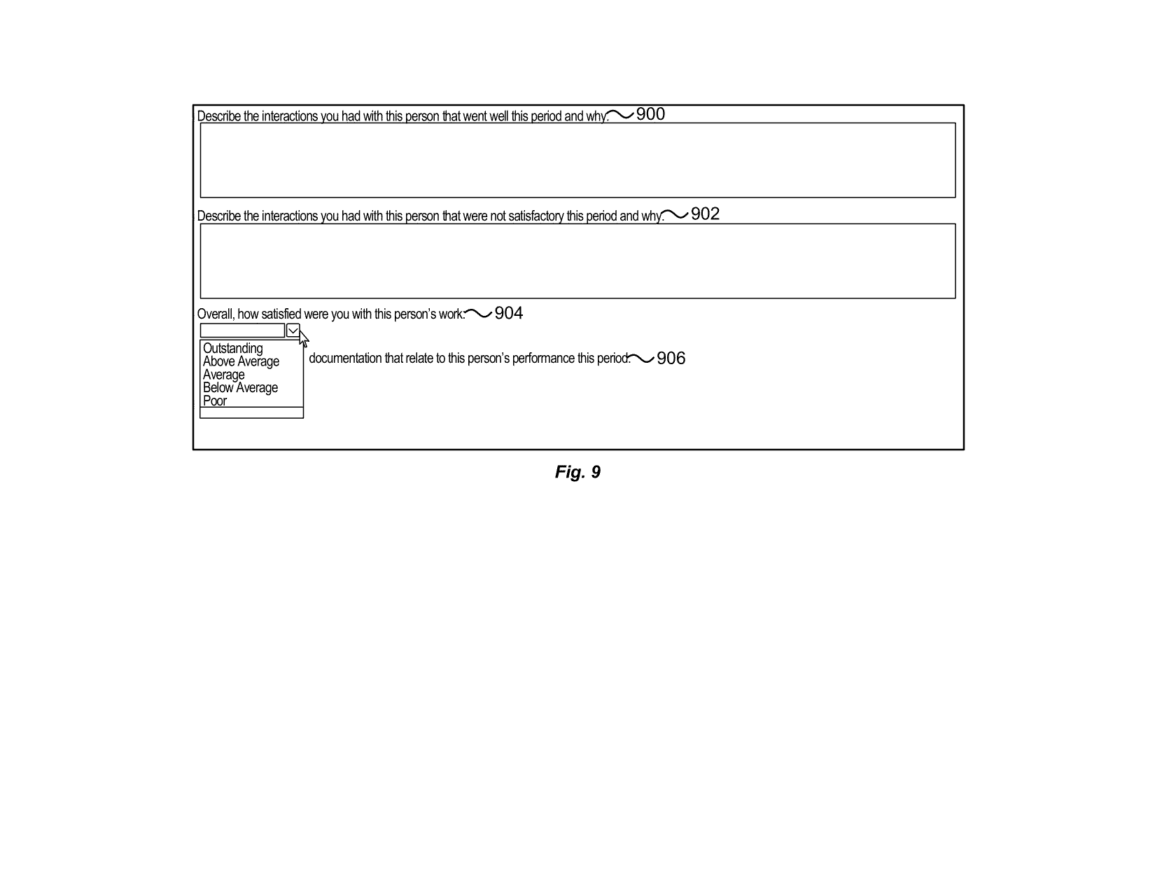

FIG. 9 illustrates an example of an implementation of a user interface for identifying top strengths for a person. FIG. 9 illustrates an example user interface for reviewing a user, such as an employee. Questions can be posed to the evaluator as shown at 900, 902, and 904. Drop-down menus and input text boxes may be provided to the evaluator. A search of input may indicate that a user has attained particular competencies and/or strengths. Documentation that relates to the performance of a user may be provided, as illustrated at 906, and likewise, the input can be searched to identify competencies and/or strengths.

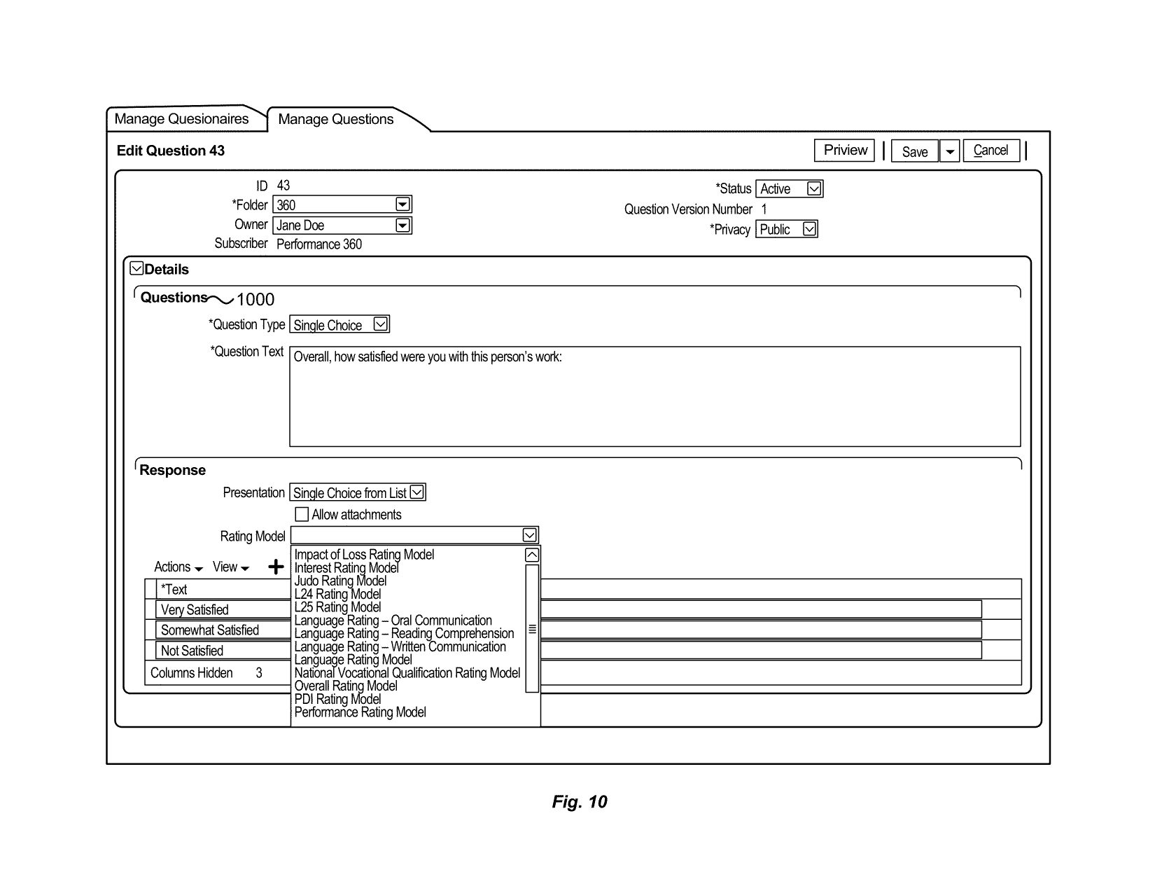

FIG. 10 illustrates an example of an implementation of a user interface for identifying top strengths for a person. FIG. 10 illustrates an example of a user interface for creating the questions illustrated in FIG. 9 to create an evaluation interface. As shown at 1000, the question text and type can be specified. As illustrated, the type may include an option of “Single Choice.” Those with skill in the art will recognize that there are a variety of question types that may be offered, including, but not limited to, radio button, type with a cap on the characters permitted in the answer, and/or any other type of question type.

Although the description has been described with respect to particular embodiments thereof, these particular embodiments are merely illustrative, and not restrictive.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method for identifying top strengths of a person, the method comprising:
receiving a definition for a strength, wherein the definition comprises a first competency, a second competency, a first weight, and a second weight;
retrieving profile information for a user from a profile management application;
computing a value for the strength using the definition and the profile information for the user; and
comparing the value for the strength with a plurality of values for the strength from a plurality of other users.

2. The method of claim 1, wherein the profile information comprises at least one of a performance assessment, a course instructor assessment, a self-assessment, and a peer assessment.

3. The method of claim 1, wherein the definition is a formula for computing the value that the user has for the strength.

4. The method of claim 1, further comprising:
receiving one or more definitions for strengths;
computing one or more values for the strengths using the one or more definitions; and
ranking strengths for the user in accordance with the one or more values generated.

5. The method of claim 1, wherein the first weight comprises a weight for the first competency in a formula for generating a value for the strength.

6. The method of claim 1, wherein the definition further comprises a third weight for a source for a competency assessment for the user.

7. The method of claim 1, wherein the profile information comprises a public profile from a social networking application.

8. A computer readable storage device having one or more instructions thereon for identifying top strengths of a person, the instructions when executed by one or more processors causing the one or more processors to carry out:
receiving a definition for a strength, wherein the definition comprises a first competency, a second competency, a first weight, and a second weight;
retrieving profile information for a user from a profile management application;
computing a value for the strength using the definition and the profile information for the user; and
comparing the value for the strength with a plurality of values for the strength from a plurality of other users.

9. The computer readable storage device of claim 8, wherein the profile information comprises at least one of a performance assessment, a course instructor assessment, a self-assessment, and a peer assessment.

10. The computer readable storage device of claim 8, wherein the definition is a formula for computing the value that the user has for the strength.

11. The computer readable storage device of claim 8, the instructions when executed further carry out:
receiving one or more definitions for strengths;
computing one or more values for the strengths using the one or more definitions; and
ranking strengths for the user in accordance with the one or more values generated.

12. The computer readable storage device of claim 8, wherein the first weight comprises a weight for the first competency in a formula for generating a value for the strength.

13. The computer readable storage device of claim 8, wherein the definition further comprises a third weight for a source for a competency assessment for the user.

14. The computer readable storage device of claim 8, wherein the profile information comprises a public profile from a social networking application.

15. An apparatus for identifying top strengths of a person, the apparatus comprising:
one or more processors; and
logic encoded in one or more tangible media for execution by the one or more processors and when executed operable to:
receive a definition for a strength, wherein the definition comprises a first competency, a second competency, a first weight, and a second weight;
retrieve profile information for a user from a profile management application;
compute a value for the strength using the definition and the profile information for the user; and
compare the value for the strength with a plurality of values for the strength from a plurality of other users.

16. The apparatus of claim 15, wherein the profile information comprises at least one of a performance assessment, a course instructor assessment, a self-assessment, and a peer assessment.

17. The apparatus of claim 15, wherein the definition is a formula for computing the value that the user has for the strength.

18. The apparatus of claim 15, logic encoded and when executed further operable to:
receive one or more definitions for strengths;
compute one or more values for the strengths using the one or more definitions; and
rank strengths for the user in accordance with the one or more values generated.

19. The apparatus of claim 15, wherein the first weight comprises a weight for the first competency in a formula for generating a value for the strength.

20. The apparatus of claim 15, wherein the definition further comprises a third weight for a source for a competency assessment for the user.
